(19) United States
(12) Patent Application Publication
(10) Pub. No.: US 2007/0101355 A1
(43) Pub. Date: May 3, 2007

(54) Device, method, and medium for expressing content dynamically

(75) Inventors: Ji-hye Chung, Seoul (KR); Hye-Jeong Lee, Seoul (KR); Yeun-bae Kim, Seongnam-si (KR); Min-kyu Park, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/529,530

(22) Filed: Sep. 29, 2006

(30) Foreign Application Priority Data
Nov. 3, 2005 (KR) 10-2005-0105015

(51) Int. Cl. H04N 5/445; G06F 3/00; G06F 13/00; H04N 7/16; H04H 9/00

(52) U.S. Cl. 725/18; 725/46; 725/45

(57) ABSTRACT

A device, method, and medium for expressing content dynamically are provided. The device for expressing content dynamically includes: a background-music-analyzing module for analyzing background music; an image-unit-group-adjusting module for adjusting attributes of a plurality of image unit groups including at least one content element and image effect element included in each image unit group according to the analyzed background music; a time-adjusting module for adjusting a length of time taken to express the attribute-adjusted image unit groups and the at least one content element included in each image unit group according to the analyzed background music; and a control module for displaying the time-adjusted image unit groups and the at least one content element included in each image unit group.

### CROSS-REFERENCE TO RELATED APPLICATIONS

This application claims the benefit of Korean Application No. 10-2005-0105015, filed Nov. 3, 2005, in the Korean Intellectual Property Office, the disclosure of which is incorporated herein by reference.

### BACKGROUND OF THE INVENTION

1. Field of the Invention

The present invention relates to a device, method, and medium for expressing content dynamically, and more particularly to a device, method, and medium for providing dynamic content.

2. Description of the Related Art

Slide shows are generally used to provide dynamic content by showing multiple pictures at specified time intervals.

In a slide show, a sequence of pictures is simply displayed one after another at specified time intervals. In other words, each picture is displayed for a specified time period and then another picture is shown. Therefore, a slide show creates static content, and does not meet the increasing demand to express content dynamically according to individual preferences.

Since multiple pictures are shown sequentially, a viewer cannot easily perceive the relationship between the pictures. That is, a slide show is limited due to its static manner of expression.

Recently, various effects, such as addition of captions to content, and pan and tilt effects have been applied to slide shows in order to avoid monotony. Despite such effects, content expressed by a slide show can still be monotonous.

Korean Unexamined Patent Application No. 2001-110178 discloses a multimedia system for synchronizing music and image tracks. The multimedia system includes a synchronization information recording apparatus for recording multiple sequence tracks having synchronization information recorded therein. The synchronization information recording apparatus incorporates and precisely controls the synchronization information in each sequence track to form a multimedia file. This prior art reference, however, discloses a time-based simple synchronization. It is still necessary to synchronize content with music and to measure the length of music, the number of pictures included in the content, and the time taken to change the pictures.

### SUMMARY OF THE INVENTION

Additional aspects, features, and/or advantages of the invention will be set forth in part in the description which follows and, in part, will be apparent from the description, or may be learned by practice of the invention.

Accordingly, the present invention solves the above-mentioned problems occurring in the prior art, and the present invention provides a device, method, and medium for synchronizing content with background music to express the content dynamically. The present invention is not limited to that stated above. Those of ordinary skill in the art will recognize additional aspects, features, and/or advantages in view of the following description of the present invention.

In accordance with one aspect of the present invention, there is provided a device for expressing content dynamically, which includes: a background-music-analyzing module analyzing background music; an image-unit-group-adjusting module adjusting attributes of a plurality of image unit groups including at least one content element and image effect element included in each image unit group according to the analyzed background music; a time-adjusting module adjusting the length of time taken to express the attribute-adjusted image unit groups and at least one content element included in each image unit group according to the analyzed background music; and a control module displaying the time-adjusted image unit groups and at least one content element included in each image unit group.

In accordance with another aspect of the present invention, there is provided a method of expressing content dynamically, which includes: analyzing background music that corresponds to a plurality of image unit groups including at least one content element; adjusting attributes of the plurality of image unit groups of at least one of content element and image effect element included in each image unit group according to the analyzed background music; adjusting the length of time taken to express the attribute-adjusted image unit groups and at least one content element included in each image unit group according to the analyzed background music; and displaying the time-adjusted image unit groups and at least one content element included in each image unit group.

In accordance with another aspect of the present invention, there is provided at least one computer readable medium storing instructions that control at least one processor to perform a method of expressing content dynamically, including: analyzing background music that corresponds to a plurality of image unit groups including at least one content element; adjusting attributes of the plurality of image unit groups of at least one of content element and image effect element included in each image unit group according to the analyzed background music; adjusting length of time taken to express the attribute-adjusted image unit groups and at least one content element included in each image unit group according to the analyzed background music; and displaying the time-adjusted image unit groups and at least one content element included in each image unit group.

### BRIEF DESCRIPTION OF THE DRAWINGS

These and/or other aspects, features, and advantages of the invention will become apparent and more readily appreciated from the following description of the exemplary embodiments, taken in conjunction with the accompanying drawings of which:

FIG. 1 is a block diagram of a device for expressing content dynamically according to an exemplary embodiment of the present invention;

FIG. 2 is a flowchart showing a process of expressing content dynamically according to an exemplary embodiment of the present invention;

FIG. 3 is a flowchart showing a process of classifying background music according to an exemplary embodiment of the present invention;

FIG. 4 is a flowchart showing a process of adjusting image unit groups according to an exemplary embodiment of the present invention; and

FIG. 5 is a flowchart showing a process of adjusting time according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, exemplary embodiments of the present invention will be described with reference to the accompanying drawings. The matters exemplified in this description are provided to assist in a comprehensive understanding of various exemplary embodiments of the present invention. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness. In the following description, the same reference numeral will be used for the same element.

The device and method for expressing content dynamically according to the present invention will be explained with reference to a block diagram and flowcharts in the accompanying drawings. It will be understood that each block of the flowcharts and combinations of the flowcharts may be implemented by computer readable instructions that can be provided to a processor of a general purpose computer, special-purpose computer or other programmable data processing apparatus. The instructions executed by the processor of the computer or other programmable data processing apparatus implement the functions specified in the flowchart blocks. These computer readable instructions may also be stored in a computer-usable or computer-readable memory that can direct a computer or other programmable data processing apparatus to function in a particular manner. The computer program instructions stored in the computer-usable or computer-readable memory can produce an article of manufacture, including instructions that implement the functions specified in the flowchart blocks. The computer program instructions may also be loaded into a computer or other programmable data processing apparatus so as to cause a series of operational steps to be performed in the computer or another programmable apparatus. The computer readable instructions executed in the computer or other programmable apparatus produce a computer implemented process, and thereby provide steps for implementing the functions specified in the flowchart blocks.

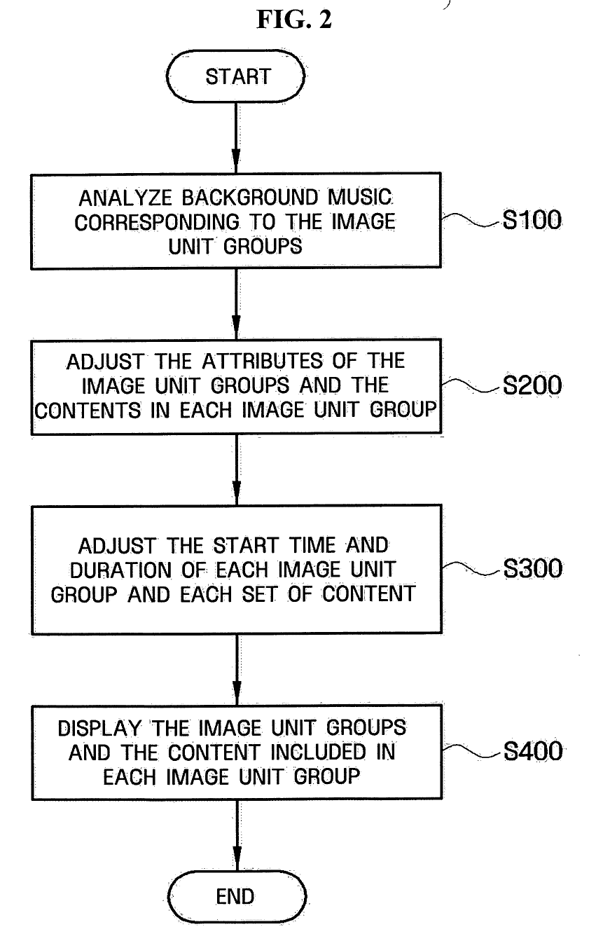

Each block in the flowcharts may represent a module, segment or portion of code, which includes one or more executable instructions for implementing the specified logical function(s). It should also be noted that in some alternative implementations, the functions noted in the blocks may occur in an order different from that noted in FIGS. 2 to 5. For example, two blocks shown in succession may in fact be executed substantially concurrently or the blocks may be executed in reverse order depending on the functionality involved.

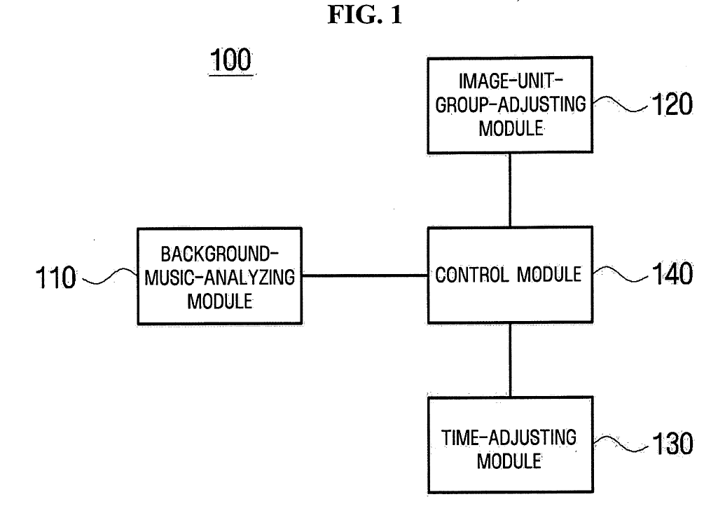

FIG. 1 is a block diagram of a device for expressing content dynamically according to an exemplary embodiment of the present invention.

Referring to FIG. 1, the device 100 for expressing content dynamically includes a background-music-analyzing module 110, an image-unit-group-adjusting module 120, a time-adjusting module 130 and a control module 140.

The background-music-analyzing module 110 can analyze background music corresponding to a plurality of image unit groups, each including at least one set of content. The background music is designated by a user or recommendation or as default, but is not limited to such designation. The content can be a photograph, a motion picture, animated text or photograph having comment. A content may also be referred to as a content element or a content item. The image unit groups are a plurality of content groups, each comprising at least one content and/or an image effect element for the content. In other words, the image unit groups include a plurality of contents and various image effect elements for expressing the contents. The image effect elements may include decorative elements, such as background music, stickers and subtitles), elements for dynamic expression, such as transitions, animations and camera work, and elements for content disposition, such as layout and timing.

The image unit groups can be classified according to the relationship between contents, image effect elements, or user preference. For example, photographs taken at the same place during the same trip have higher relevancy than those taken at different places during different trips. Such photographs having high relevancy can be included in the same image unit group. Similarly, photographs stored in the same layout and with the same background music can be included in the same image unit group.

The background-music-analyzing module 110 can analyze the tempo of a selected background music. According to the present invention, the background-music-analyzing module 110 sets multiple sound levels and analyzes the distribution of the different sound levels in the background music per unit time in order to classify the tempo of the background music. For example, each background song can be classified into slow, middle or fast tempo according to the distribution of four sound levels in the music per unit time. If relatively high sound levels are repeatedly detected over a predetermined number per unit time (for example, every 10 seconds, 60 seconds or 100 seconds) at short intervals, the background-music-analyzing module 110 will classify the background music into fast-tempo.

The image-unit-group-adjusting module 120 adjusts the attributes of the plurality of image unit groups and of the contents included in each image unit group according to the background music classified by the background-music-analyzing module 110. The attributes of the image unit groups refer to the start time and duration of each image unit group and the image effect elements of the contents. The attributes of the contents in each image unit group refer to the number of the contents and the image expression elements for expressing the contents. If the start time and duration of any image unit group are the same, it will be recognized that the image unit group is not being displayed.

In other words, to create an image using a plurality of contents, the image-unit-group-adjusting module 120 determines the number of contents which will be included in each image unit group according to the effect of each image unit group, correlation between the number of contents and the background music, and mutual relevancy between the contents. If the maximum and minimum numbers of contents that can be included in an image unit group are fixed, the image-unit-group-adjusting module 120 will determine the number of contents within the fixed range.

The effect of each image unit group and the correlation between the number of contents and the background music are expected based on a method of synchronizing an image on music to create a dynamic image. If the number of contents is not sufficient in view of the length of the background music, the number of contents can be increased. Alternatively, another image expression effect can be added to meet the length of the background music. If the length of the background music is too short in view of the number of contents, the same music can be repeatedly reproduced or any additional background music can be added to adjust the length of music to the number of contents.

Supposing that a plurality of contents included in an image unit group are photographs and that an image expression element for enlarging each photograph for a predetermined period of time and restoring to an original size is included, the image-unit-group-adjusting module 120 may change the number of photographs included in the image unit group according to the length of background music or adjust the time period during which the photograph is enlarged in order to meet the length of background music.

The time-adjusting module 130 adjusts the time allocated to express the plurality of image unit groups and the contents included in each image unit group according to the selected background music. According to the present invention, the time adjusted by the time-adjusting module 130 can be construed as the time allocated to change each image unit group and each set of content in a specific image unit group. The time-adjusting module 130 may or may not align the start point of the background music to the start point of the image unit groups. For example, when the background music starts and its sound reaches a predetermined level, the time-adjusting module 130 can make the image unit groups start to be displayed. In addition, the time-adjusting module 130 may or may not align the end point of the background music to that of the image unit groups.

It is also possible to adjust the locations of start content and end content before or after starting to display the plurality of image unit groups. The start and end contents can be designated by the user or recommendation or as default. The time allocated to the start and end contents may vary depending on the length of the image unit groups and that of the background music.

The time-adjusting module 130 adjusts the time allocated to each image unit group and to the contents and elements included in each image unit group, as well as the locations of the plurality of image unit groups. In other words, the time-adjusting module 130 adjusts the time period during which each image unit group is displayed (i.e. the period between the starting of an image unit group and the display of a subsequent image unit group) and the time period during which each set of content in a specific image unit group is displayed according to a specific image effect element. In addition, the time-adjusting module 130 adjusts the time allocated to change the image unit groups and the contents included in each image unit group when the background music is played of a predetermined sound level. For example, the time-adjusting module 130 can adjust the time allocated to change the image unit groups and the contents in each image unit group at the point of a peak sound level or a big variation in sound levels of the background music.

The control module 140 displays the plurality of image unit groups and the contents included in each image unit group, which were time-adjusted by the time-adjusting module 130, in synchronization with the selected background music. The image effect elements as explained above are used to express the contents dynamically, rather than to simply display the contents one after another. The image unit groups changing according to the selected background music produce a dynamic image. FIG. 2 is a flowchart showing a process of expressing content dynamically according to an exemplary embodiment of the present invention.

Referring to FIG. 2, a first step for expressing content dynamically is to classify the background music corresponding to a plurality of image unit groups (S100). The corresponding background music can be selected by the user or recommendation, or can be designated as default. The classification of the background music is performed by the background-music-analyzing module 110. The background-music-analyzing module 110 can classify the tempo of the background music according to the length and sound levels of the music. According to an exemplary embodiment of the present invention, it is assumed that each background song can be classified into slow, middle or fast tempo.

The image-unit-group-adjusting module 120 adjusts the attributes of the plurality of image unit groups and of the contents included in each image unit group (S200). To be specific, the image-unit-group-adjusting module 120 may adjust the time allocated to change the image unit groups, the time allocated to change the contents included in each image unit group, or the number of contents according to the length or tempo of the background music. For example, if the time taken to change the plurality of image unit groups is longer than the length of the background music, the image-unit-group-adjusting module 120 can reduce the time allocated to change the image unit groups, the time allocated to change the contents in each image unit group, or the number of contents included in each image unit group. Also, any content having a lower relevancy with the other contents in the same image unit group can be displayed as a sticker form which is not changed in the image unit group.

When the attribute adjustment is completed by the image-unit-group-adjusting module 120, the time-adjusting module 130 adjusts the start time and duration of each image unit group and each set of content included in each image unit group to correspond to the background music (S300). More specifically, the time-adjusting module 130 adjusts the start time and duration of each of the image unit groups, the time allocated to change the image unit groups, the start time and duration of each set of content included in each image unit group, and the time allocated to change the contents in each image unit group according to the length of the background music. The start time or the duration can be a point at which the background music is played of a predetermined sound level. For example, the image unit groups and the contents in each image unit group can be changed at a point of the peak sound level of the background music.

Then the time-adjusted image unit groups and contents included in each image unit group are displayed (S400).

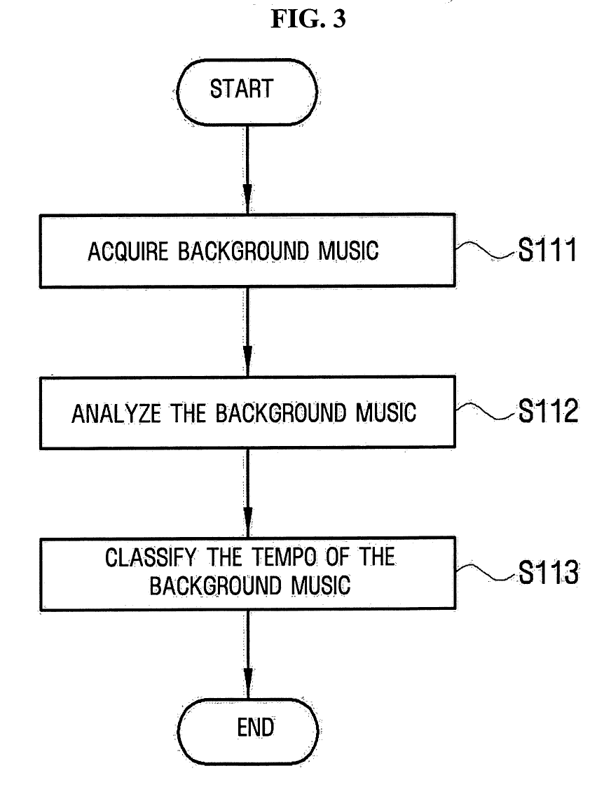

FIG. 3 is a flowchart showing a process of classifying background music according to an exemplary embodiment of the present invention.

Referring to FIG. 3, as a first step for classifying background music, the background-music-analyzing module 110 acquires background music selected by the user (S111).

The background-music-analyzing module 110 analyzes the sound levels in the acquired background music (S112). According to an exemplary embodiment of the present invention, it is assumed that the sound of the background music has four different levels. However, the number of sound levels is not limited to four. More or less levels of sound can be set.

The background-music-analyzing module 110 classifies the tempo of the background music based on the analyzed sound levels in the music (S113). The background music can be classified into slow, middle or fast tempo according to the distribution of sound levels (or the frequency of a specific sound level) in the background music.

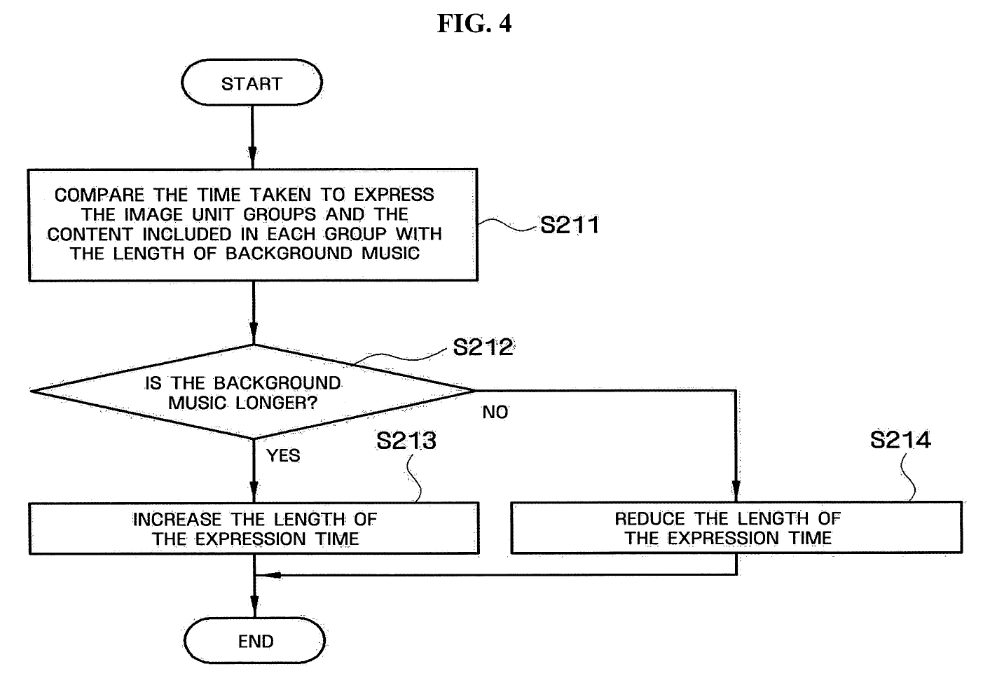

FIG. 4 is a flowchart showing a process of adjusting image unit groups according to an exemplary embodiment of the present invention.

Referring to FIG. 4, when the classification of the background music is completed through the process of FIG. 3, the image-unit-group-adjusting module 120 compares the time taken to express the plurality of image unit groups and the contents included in each image unit group with the length of the background music (S211).

If the background music is longer than the time taken to express the image unit groups and the contents in each image unit group (S212), the image-unit-group-adjusting module 120 will increase the length of time taken to express the image unit groups and the contents in each image unit group (S213). The length of time taken to express the image unit groups and the contents in each image unit group may include the time taken to change the image unit groups, the number of contents in an image unit group and the time taken to change the contents in an image unit group. If the background music is longer than the length of time taken to express the image unit groups and the contents in each image unit group, the image-unit-group-adjusting module 120 will increase the time taken to change the image unit groups, the number of contents in an image unit group and the time taken to change the contents in an image unit group. For example, if an image expression effect is used to display one content item in an enlarged size for a predetermined period of time and then display another in the same manner, the image-unit-group-adjusting module 120 may increase the period of time for which each set of content is enlarged.

If the background music is shorter than the length of time taken to express the image unit groups and the contents in each image unit group, the image-unit-group-adjusting module 120 will reduce the length of time taken to express the image unit groups and the contents in each image unit group (S214). In other words, the image-unit-group-adjusting module 120 will reduce the time taken to change the image unit groups, the number of contents in an image unit group and the time taken to change the contents in an image unit group. Also, the image-unit-group-adjusting module 120 can reduce the time taken to express each set of content. For example, if an image expression effect is used to display one content item in an enlarged size for a predetermined period of time and then display another in the same manner, the image-unit-group-adjusting module 120 can reduce the period of time for which each set of content is enlarged.

The image-unit-group-adjusting module 120 can adjust the time taken to change the image unit groups, the number of contents in an image unit group and the time taken to change the contents in an image unit group according to the length of the background music. Alternatively, the image-unit-group-adjusting module 120 can adjust the length of the background music to meet the length of time taken to express the image unit groups and the contents in each image unit group. For example, if the background music is shorter than the length of time taken to express the image unit groups and the contents in each image unit group, the same background music can be repeatedly played or another song can be added to increase the overall length of the background music.

As explained above, the image-unit-group-adjusting module 120 compares the time taken to express the image unit groups and the contents in each image unit group with the length of the background music, and then adjusts the expression time or the length of the background music based on the comparison results.

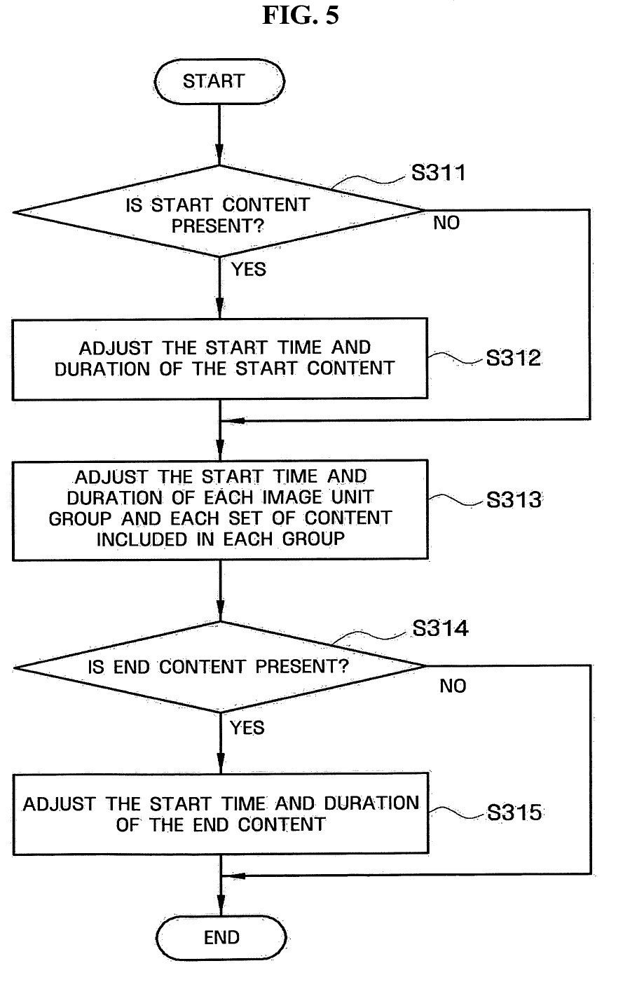

FIG. 5 is a flowchart showing a process of adjusting time according to an exemplary embodiment of the present invention.

Referring to FIG. 5, the time-adjusting module 130 determines the presence of start content which will be displayed before the display of the image unit groups (S311). In an exemplary embodiment of the present invention, it is assumed that a motion picture is used as the start content. However, the start content is not limited to a motion picture, but can be any form of content.

If start content is present, the time-adjusting module 130 will adjust the start time and duration of the start content (S312).

Subsequently, the time-adjusting module 130 will adjust the start time and duration of each of the image unit groups, the time allocated to change the image unit groups, the start time and duration of each set of content included in each image unit group, and the time allocated to change the contents in each image unit group (S313).

Upon the time adjustment, the time-adjusting module 130 determines the presence of end content (S314). In an exemplary embodiment of the present invention, it is assumed that a motion picture is used as the end content. However, the end content is not limited to a motion picture, but can be any form of content.

If end content is present, the time-adjusting module 130 will adjust the start time and duration of the end content (S315).

As explained above, the start time and duration of each image unit group and of each set of content included in each image unit group are adjusted according to the length of the background music. In other words, the start time and duration of each image unit group and each set of content are automatically adjusted with a change of the length of the background music, thereby dynamically expressing the plurality of image unit groups and the contents in each image unit group in synchronization with the background music, without the need to perform any separate time synchronization process.

In connection with the above description, a “module” means a hardware component, such as Field Programmable Gate Array (FPGA) or an Application-Specific Integrated Circuit (ASIC), which performs certain functions or tasks. A module includes, but is not limited to, software or hardware components. A module may be configured to reside in an addressable storage medium or to execute one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, wired storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions is stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC).

As explained above, the present invention provides a device, method, and medium for expressing content dynamically. The device, method, and medium can adjust the length of time taken to express and change a plurality of image unit groups and content included in each image unit group in order to synchronize the display of the image unit groups and the content in each image unit group with background music, thereby providing a dynamic image.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A device for expressing content dynamically, comprising:
a background-music-analyzing module analyzing background music;
an image-unit-group-adjusting module adjusting attributes of a plurality of image unit groups including at least one of content element and image effect element included in each image unit group according to the analyzed background music;
a time-adjusting module adjusting a length of time taken to express the attribute-adjusted image unit groups and at least one content element included in each image unit group according to the analyzed background music; and
a control module displaying the time-adjusted image unit groups and at least one content element included in each image unit group.

2. The device of claim 1, wherein the at least one content element included in each image unit group is classified by at least one of relationship between the content elements, image effect elements, and user preferences.

3. The device of claim 1, wherein the background-music-analyzing module analyzes tempo of the background music according to changes of sound levels in the background music per unit time.

4. The device of claim 1, wherein the image-unit-group-adjusting module adjusts length of the background music according to attributes of the plurality of image unit groups and of the at least one content element included in each image unit group.

5. The device of claim 1, wherein the attributes of the image unit groups include time allocated to change the image unit groups.

6. The device of claim 1, wherein the attributes of the image unit groups include start time and duration time of each image unit group.

7. The device of claim 1, wherein the attributes of the at least one content element include at least one of number of the content elements included in each image unit group and time allocated to change the content.

8. The device of claim 1, wherein the attributes of the at least one content element include start time and duration time of the at least one content element.

9. The device of claim 1, wherein the time-adjusting module adjusts the start time and duration time of each image unit group and each content element included in each image unit group according to the analyzed background music.

10. The device of claim 9, wherein the time-adjusting module adjusts start time and duration time of start content element and end content element that will be displayed before and after the display of the plurality of image unit groups.

11. A method of expressing content dynamically, comprising:
analyzing background music that corresponds to a plurality of image unit groups including at least one content element;
adjusting attributes of the plurality of image unit groups and at least one of content element and image effect element included in each image unit group according to the analyzed background music;
adjusting length of time taken to express the attribute-adjusted image unit groups and at least one content element included in each image unit group according to the analyzed background music; and
displaying the time-adjusted image unit groups and at least one content element included in each image unit group.

12. The method of claim 11, wherein the plurality of image unit groups are classified by at least one of relationship between content elements, image effect elements, and user preferences.

13. The method of claim 11, wherein the analyzing of the background music includes analyzing tempo of the background music according to changes of sound levels in the background music per unit time.

14. The method of claim 13, wherein the adjusting of the attributes includes adjusting length of the background music according to the attributes of the image unit groups and of the at least one content included in each image unit group.

15. The method of claim 11, wherein the attributes of the image unit groups include time allocated to change the image unit groups.

16. The method of claim 11, wherein the attributes of the image unit groups include start time and duration time of each image unit group.

17. The method of claim 11, wherein the attributes of the at least one content element include at least one of number of the at least one content element included in each image unit group and time allocated to change the at least one content element.

18. The method of claim 11, wherein the attributes of the at least one content element include start time and duration time of the at least one content element.

19. The method of claim 11, wherein the adjusting of the time includes adjusting start time and duration time of each image unit group and the at least one content element included in each image unit group according to the analyzed background music.

20. The method of claim 19, wherein the adjusting of the time includes adjusting start time and duration time of start content element and end content element that will be displayed before and after the display of the plurality of image unit groups.

21. At least one computer readable medium storing instructions that control at least one processor to perform a method of expressing content dynamically, comprising:
analyzing background music that corresponds to a plurality of image unit groups including at least one content element;
adjusting attributes of the plurality of image unit groups and at least one of content element and image effect element included in each image unit group according to the analyzed background music;
adjusting length of time taken to express the attribute-adjusted image unit groups and the at least one content element included in each image unit group according to the analyzed background music; and
displaying the time-adjusted image unit groups and the at least one content element included in each image unit group.
